(19) United States
(12) Patent Application Publication
(10) Pub. No.: US 2022/0262012 A1
(43) Pub. Date: Aug. 18, 2022

(54) Image Processing Method and Apparatus, and Storage Medium

(71) Applicant: Beijing Sensetime Technology Development Co., Ltd., Beijing (CN)

(72) Inventors: Siyao Li, Beijing (CN); Xiangyu Xu, Beijing (CN); Wenxiu Sun, Beijing (CN)

(73) Assignee: Beijing Sensetime Technology Development Co., Ltd., Beijing (CN)

(21) Appl. No.: 17/709,695

(22) Filed: Mar. 31, 2022

Related U.S. Application Data
(63) Continuation of application No. PCT/CN2019/127981, filed on Dec. 24, 2019.

(30) Foreign Application Priority Data
Oct. 30, 2019 (CN) 201911041851.X

(51) Int. Cl. G06T 7/215; G06N 3/04

(52) U.S. Cl. CPC G06T 7/215; G06T 2207/20081; G06T 2207/20084; G06N 3/0454

(57) ABSTRACT

A method for image processing comprises: acquiring first, second, third, and fourth optical flow maps of t-th to (t−1)-th frame images, t-th to (t+1)-th frame images, (t+1)-th to t-th frame images, and (t+1)-th to (t+2)-th frame images, respectively, wherein t is an integer; determining first and second interpolation optical flow maps according to the first and second optical flow maps, and the third and fourth optical flow maps, respectively; determining a first interpolation frame image according to the first interpolation optical flow map and the t-th frame image, and a second interpolation frame image according to the second interpolation optical flow map and the (t+1)-th frame image; and fusing the first and second interpolation frame images to obtain an interpolation frame image to be interpolated between the t-th and (t+1)-th frame images. The embodiment of the present disclosure is capable of improving the accuracy of the obtained interpolation frame image.

### CROSS REFERENCE TO RELATED APPLICATIONS

The present application is a continuation of and claims priority under 35 U.S.C. 120 to PCT Application No. PCT/CN2019/127981, filed on Dec. 24, 2019 and titled “Image Processing Method and Apparatus, Electronic Device and Storage Medium”, which claims priority to Chinese Patent Application No. 201911041851.X titled “IMAGE PROCESSING METHOD AND DEVICE, ELECTRONIC APPARATUS AND STORAGE MEDIUM”, filed on Oct. 30, 2019 with the CNIPA. All the above-referenced priority documents are incorporated herein by reference in their entireties.

### TECHNICAL FIELD

The present disclosure relates to the field of computer technology, in particular to an image processing method and device, an electronic apparatus and a storage medium.

### BACKGROUND

In order to make the motion in a video look smoother, usually an intermediate frame image is generated between every two frame images of the video and interpolated between the two frame images.

The related art is directly or indirectly premised on uniform motion between the two frame images, and generates an intermediate frame image using the two frame images to be interpolated.

### SUMMARY

The present disclosure proposes a technical solution for image processing.

According to one aspect of the present disclosure, provided is an image processing method, comprising:

acquiring a first optical flow map of a t-th frame image to a (t−1)-th frame image, a second optical flow map of the t-th frame image to a (t+1)-th frame image, a third optical flow map of the (t+1)-th frame image to the t-th frame image, and a fourth optical flow map of the (t+1)-th frame image to a (t+2)-th frame image, wherein t is an integer;

determining a first interpolation frame optical flow map according to the first optical flow map and the second optical flow map, and determining a second interpolation frame optical flow map according to the third optical flow map and the fourth optical flow map;

determining a first interpolation frame image according to the first interpolation frame optical flow map and the t-th frame image, and determining a second interpolation frame image according to the second interpolation frame optical flow map image and the (t+1)-th frame image; and

fusing the first interpolation frame image and the second interpolation frame image to obtain an interpolation frame image to be interpolated between the t-th frame image and the (t+1)-th frame image.

According to one aspect of the present disclosure, provided is an image processing device comprising:

an acquisition module configured to acquire a first optical flow map of a t-th frame image to a (t−1)-th frame image, a second optical flow map of the t-th frame image to a (t+1)-th frame image, a third optical flow map of the (t+1)-th frame image to the t-th frame image, and a fourth optical flow map of the (t+1)-th frame image to the (t+2)-th frame image, wherein t is an integer;

a first determination module configured to determine a first interpolation frame optical flow map according to the first optical flow map and the second optical flow map, and determine a second interpolation frame optical flow map according to the third optical flow map and the fourth optical flow map;

a second determination module configured to determine a first interpolation frame image according to the first interpolation frame optical flow map and the t-th frame image, and determine a second interpolation frame image according to the second interpolation frame optical flow map image and the (t+1)-th frame image; and

a fusion module configured to fuse the first interpolation frame image and the second interpolation frame image to obtain an interpolation frame image to be interpolated between the t-th frame image and the (t+1)-th frame image.

According to one aspect of the present disclosure, provided is an electronic apparatus comprising: a processor; a memory configured to store processor executable instructions; wherein the processor is configured to invoke instructions stored by the memory to execute the above method.

According to one aspect of the present disclosure, provided is a computer readable storage medium which stores computer program instructions, the computer program instructions are executed by a processor to implement the above method.

According to one aspect of the present disclosure, provided is a computer program comprising computer readable codes which, when run in an electronic apparatus, causes a processor of the electronic apparatus to execute the above method.

It is appreciated that the foregoing general description and the subsequent detailed description are merely exemplary and illustrative, and are not intended to limit the present disclosure. Additional features and aspects of the present disclosure will become apparent from the following detailed description of exemplary embodiments with reference to the attached drawings.

### BRIEF DESCRIPTION OF THE DRAWINGS

The drawings here, which are incorporated in and constitute part of the specification, illustrate embodiments conforming to the present disclosure, and serve to explain the technical solutions of the present disclosure together with the description.

FIG. 1 illustrates a flow chart of the image processing method according to the embodiment of the present disclosure;

FIG. 2 illustrates a schematic diagram of the image processing method according to the embodiment of the present disclosure;

FIG. 3 illustrates a block diagram of the image processing device according to the embodiment of the present disclosure;

FIG. 4 illustrates a block diagram of an electronic apparatus 800 according to the embodiment of the present disclosure;

FIG. 5 illustrates a block diagram of an electronic apparatus 1900 according to the embodiment of the present disclosure.

### DETAILED DESCRIPTION

Various exemplary examples, features and aspects of the present disclosure will be described in detail with reference to the drawings. The same reference numerals in the drawings represent parts having the same or similar functions. Although various aspects of the examples are shown in the drawings, it is unnecessary to proportionally draw the drawings unless otherwise specified.

Herein the term “exemplary” means “used as an instance or example, or explanatory”. An “exemplary” example given here is not necessarily construed as being superior to or better than other examples.

Herein the term “and/or” describes a relation between associated objects and indicates three possible relations. For example, the phrase “A and/or B” indicates a case where only A is present, a case where A and B are both present, and a case where only B is present. In addition, the term “at least one” herein indicates any one of a plurality or a random combination of at least two of a plurality. For example, including at least one of A, B and C means including any one or more elements selected from a group consisting of A, B and C.

Numerous details are given in the following examples for the purpose of better explaining the present disclosure. It should be understood by a person skilled in the art that the present disclosure can still be realized even without some of those details. In some of the examples, methods, means, units and circuits that are well known to a person skilled in the art are not described in detail so that the principle of the present disclosure become apparent.

A segment of video is composed of a set of consecutive video frames. Video interpolation technology enables generating an intermediate frame image between every two frames of a segment of video to increase the frame rate of the video, so that the motion in the video seems smoother. A slow motion effect is produced when the generated video with higher frame rate is played at the same frame rate. However, during the process of interpolation, the motion in the actual scenario may be complex and non-uniform, causing the generated intermediate frame image to be less accurate. On this basis, the present disclosure proposes an image processing method that enables improving the accuracy of the generated intermediate frame image, thereby solving the above problem.

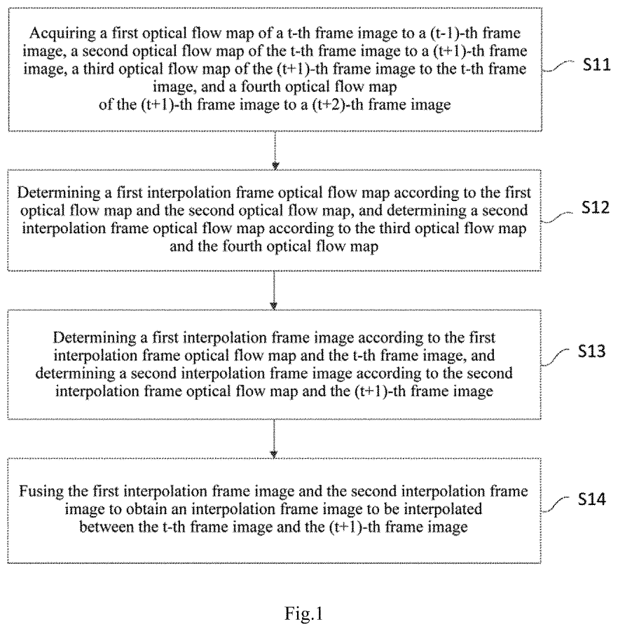

FIG. 1 illustrates a flow chart of the image processing method according to the embodiment of the present disclosure. The image processing method may be executed by a terminal apparatus or other processing apparatus. The terminal apparatus may be a user equipment (UE), a mobile apparatus, a user terminal, a terminal, a cellular phone, a wireless phone, a Personal Digital Assistant (PDA), a handheld apparatus, a computing apparatus, a vehicle on-board apparatus, a wearable apparatus, etc. In some possible implementations, the image processing method may be implemented by a processor invoking computer readable instructions stored in a memory.

As shown in FIG. 1, the method may include:

In step S11, acquiring a first optical flow map of the t-th frame image to the (t−1)-th frame image, a second optical flow map of the t-th frame image to the (t+1)-th frame image, a third optical flow map of the (t+1)-th frame image to the t-th frame image, and a fourth optical flow map of the (t+1)-th frame image to the (t+2)-th frame image, wherein t is an integer.

For example, the t-th frame image and the (t+1)-th frame image may be two frames between which a frame is to be interpolated; the (t−1)-th frame image, the t-th frame image, the (t+1)-th frame image, and the (t+2)-th frame image are four consecutive images. For example, an image before and adjacent to the t-th frame image may be acquired as the (t−1)-th frame image, and an image after and adjacent to the (t+1)-th frame image may be acquired as the (t+2)-th frame image.

In a possible implementation, acquiring a first optical flow map of a t-th frame image to a (t−1)-th frame image, a second optical flow map of the t-th frame image to a (t+1)-th frame image, a third optical flow map of the (t+1)-th frame image to the t-th frame image, and a fourth optical flow map of the (t+1)-th frame image to the (t+2)-th frame image may include:

performing optical flow prediction on the t-th frame image and the (t−1)-th frame image to obtain a first optical flow map of the t-th frame image to the (t−1)-th frame image, performing optical flow prediction on the t-th frame image and the (t+1)-th frame image to obtain the second optical flow map of the t-th frame image to the (t+1)-th frame image, performing optical flow prediction on the (t+1)-th frame image and the t-th frame image to obtain the third optical flow map of the (t+1)-th frame image to the t-th frame image, and performing optical flow prediction on the (t+1)-th frame image and the (t+2)-th frame image to obtain the fourth optical flow map of the (t+1)-th frame image to the (t+2)-th frame image.

For example, an optical flow map is image information describing a change of a target object in the image, which is consisted of optical flow of the target object at each position. Optical flow prediction may be performed using the (t−1)-th frame image and the t-th frame image to determine the first optical flow map of the t-th frame image to the (t−1)-th frame image. Optical flow prediction may be performed using the t-th frame image and (t+1)-th frame image to determine the second optical flow map of the t-th frame image to the (t+1)-th frame image. Optical flow prediction may be performed using the (t+1)-th frame image and the t-th frame image to determine the third optical flow map of the (t+1)-th frame image to the t-th frame image. And optical flow prediction may be performed using the (t+1)-th frame image and the (t+2)-th frame image to determine the fourth optical flow map of the (t+1)-th frame image to the (t+2)-th frame image. The optical flow prediction may be implemented by a pre-trained neural network configured to perform optical flow prediction, or may be implemented by other methods, which will not be detailed herein.

In step S12, determining a first interpolation frame optical flow map according to the first optical flow map and the second optical flow map, and determining a second interpolation frame optical flow map according to the third optical flow map and the fourth optical flow map.

For example, assuming that the t-th frame image is an image frame corresponding to a moment 0 and the (t+1)-th frame image is an image frame corresponding to a moment 1, the (t−1)-th frame image will be the image frame corresponding to a moment −1, and the (t+2)-th frame will be the image frame corresponding to a moment 2.

Assuming that the elements in the video performs a uniformly accelerated motion, then an optical flow value in any position in the first interpolation frame optical flow map may be determined using the change of optical flow value of the position in the first optical flow map and the second optical flow map, and an optical flow value in any position in the second interpolation frame optical flow map may be determined using the change of optical flow value of the position in the third optical flow map and the fourth optical flow map.

In a possible implementation, determining a first interpolation frame optical flow map according to the first optical flow map and the second optical flow map, and determining a second interpolation frame optical flow map according to the third optical flow map and the fourth optical flow map may include:

determining a first interpolation frame optical flow map according to the first optical flow map, the second optical flow map, and a preset interpolation time, and determining a second interpolation frame optical flow map according to the third optical flow map and the fourth optical flow map, wherein the preset interpolation time is any time in a time interval between a time of acquiring the t-th frame image and a time of acquiring the (t+1)-th frame image.

The preset interpolation time may be any time in the time interval between the time of acquiring the t-th frame image and the time of acquiring the (t+1)-th frame image. For example, in a case where the time interval between the t-th frame image and the (t+1)-th frame image is Is, the preset interpolation time may be set as any time between 0 to 1s. Assuming that the elements in the video perform a uniformly accelerated motion, then the optical flow of an element from the position x₀ in the t-th frame image to the position x₋₁ in the (t−1)-th frame image may be expressed as Equation 1, the optical flow of an element from the position x₀ in the t-th frame image to the position x₁ in the (t+1)-th frame image may be expressed as Equation 2, and the optical flow of an element from the position x₀ in the t-th frame image to the position xₛ in the interpolation frame image corresponding to the moment s is expressed as Equation 3:

$$\begin{matrix}{f}_{0 -> - 1} ( {x}_{0} ) = {x}_{- 1} - {x}_{0} = - {v}_{0} + \frac{1}{2} a \cdot {1}^{2} & ( Equation 1 ) \\ {f}_{0 -> 1} ( {x}_{0} ) = {x}_{1} - {x}_{0} = {v}_{0} + \frac{1}{2} a \cdot {1}^{2} & ( Equation 2 ) \\ {f}_{0 -> s} ( {x}_{0} ) = {x}_{s} - {x}_{0} = {v}_{0} s + \frac{1}{2} a \cdot {s}^{2} & ( Equation 3 )\end{matrix}$$

wherein f_{0->-1} indicates a first optical flow of the element from an image corresponding to the moment 0 to the image corresponding to the moment −1, f_{0->1} indicates a second optical flow of the element from an image corresponding to the moment 0 to the image corresponding to the moment 1, f_{0->s} indicates a first interpolation frame optical flow of the element from an image corresponding to the moment 0 to the first interpolation frame image corresponding to the moment s, x₋₁ indicates the position of the element in the image corresponding to the moment −1, x₀ indicates the position of the element in the image corresponding to the moment 0, x₁ indicates the position of the element in the image corresponding to the moment 1, xₛ indicates the position of the element in the image corresponding to the moment s, v₀ indicates the speed of the element moving in the image corresponding to the moment 0, and a indicates the acceleration of the element moving in the image.

Further, based on Equation 1, Equation 2 and Equation 3, the first interpolation frame optical flow of the element from the t-th frame image corresponding to the moment 0 to the first interpolation frame image corresponding to the moment s is expressed as Equation 4:

$${f}_{0 -> s} ( {x}_{0} ) = ( {f}_{0 -> 1} + {f}_{0 -> - 1} ) / 2 \cdot {s}^{2} + ( {f}_{0 -> 1} - {f}_{0 -> - 1} ) / 2 \cdot s \qquad ( Equation 4 )$$

Similarly, the second interpolation frame optical flow of the element from the (t+1)-th frame image corresponding to the moment 1 to the second interpolation frame image corresponding to the moment s is expressed as Equation 5:

$${f}_{1 -> s} ( {x}_{0} ) = ( {f}_{1 -> 0} + {f}_{1 -> 2} ) / 2 \cdot {( 1 - s )}^{2} + ( {f}_{1 -> 0} + {f}_{1 -> 2} ) / 2 \cdot ( 1 - s ) \qquad ( Equation 5 )$$

wherein, f_{1->s} indicates the second interpolation frame optical flow of the element from the image corresponding to the moment 1 to the second interpolation frame image corresponding to the moment s, f_{1->0} indicates the third optical flow of the element from the image corresponding to the moment 1 to the image corresponding to the moment 0, and f_{1->2} indicates the fourth optical flow of the element from the image corresponding to the moment 1 to the image corresponding to the moment 2.

By Equation 4, it is possible to determine the first interpolation frame optical flow according to the first optical flow, the second optical flow and the preset interpolation time. The first interpolation frame optical flow of each element may form the first interpolation frame optical flow map. By Equation 5, it is possible to determine the second interpolation frame optical flow according to the third optical flow, the fourth optical flow and the preset interpolation time. The second interpolation frame optical flow of each element may form the second interpolation frame optical flow map.

It should be noted that, the interpolation time may be any time between the t-th frame image and the (t+1)-th frame image; it may correspond to one time value or correspond to a plurality of different time values. In the case where the interpolation time corresponds to a plurality of different time values, the first interpolation frame optical flow map and the second interpolation frame optical flow map corresponding to different interpolation times may be determined using Equation 4 and Equation 5, respectively.

In step S13, determining a first interpolation frame image according to the first interpolation frame optical flow map and the t-th frame image, and determining a second interpolation frame image according to the second interpolation frame optical flow map image and the (t+1)-th frame image.

For example, the first interpolation frame optical flow map is an optical flow map of the t-th frame image to the first interpolation frame image. Hence, by guiding the motion in the t-th frame image using the first interpolation frame optical flow map, the first interpolation frame image may be obtained. Similarly, the second interpolation frame optical flow map is an optical flow map of the (t+1)-th frame image to the second interpolation frame image. Hence, by guiding the motion in the (t+1)-th frame image using the second interpolation frame optical flow map, the second interpolation frame image may be obtained.

In step S14, fusing the first interpolation frame image and the second interpolation frame image to obtain an interpolation frame image to be interpolated between the t-th frame image and the (t+1)-th frame image.

For example, the first interpolation frame image and the second interpolation frame image may be fused (e.g., superimposing the first interpolation frame image with the second interpolation frame image). The result of the fusion is the interpolation frame image to be interpolated between the t-th frame image and the (t+1)-th frame image.

As such, for the t-th frame image and the (t+1)-th frame image for interpolation, optical flow prediction may be performed on the (t−1)-th frame image, the t-th frame image, the (t+1)-th frame image, and the (t+2)-th frame image, respectively, to obtain the first optical flow map of the t-th frame image to the (t−1)-th frame image, the second optical flow map of the t-th frame image to the (t+1)-th frame image, the third optical flow map of the (t+1)-th frame image to the t-th frame image, and the fourth optical flow map of the (t+1)-th frame image to the (t+2)-th frame image. Further, the first interpolation frame optical flow map is determined according to the first optical flow map, the second optical flow map and the preset interpolation time; and the second interpolation frame optical flow map is determined according to the third optical flow map, the fourth optical flow map and the interpolation time. The first interpolation frame image is determined according to the first interpolation frame optical flow map and the t-th frame image; and the second interpolation frame image is determined according to the second interpolation frame optical flow map image and the (t+1)-th frame image. The first interpolation frame image and the second interpolation frame image are fused to obtain an interpolation frame image to be interpolated between the t-th frame image and the (t+1)-th frame image. According to the image processing method provided in the embodiment of the present disclosure, it is possible to determine the interpolation frame image based on a plurality of frame images and sense the acceleration of an object moving in the video, thereby improving the accuracy of the obtained interpolation frame image, so that it is possible to make the interpolated video with high frame rate smoother and more natural, and achieve a better visual effect.

In a possible implementation, the determining a first interpolation frame image according to the first interpolation frame optical flow map and the t-th frame image, and determining a second interpolation frame image according to the second interpolation frame optical flow map and the (t+1)-th frame image may include:

reversing the first interpolation frame optical flow map and the second interpolation frame optical flow map to obtain a reversed first interpolation frame optical flow map and a reversed second interpolation frame optical flow map; and

determining a first interpolation frame image according to the reversed first interpolation frame optical flow map and the t-th frame image, and determining a second interpolation frame image according to the reversed second interpolation frame optical flow map and the (t+1)-th frame image.

In order to further improve the accuracy of the obtained interpolation frame image, the first interpolation frame optical flow map and the second interpolation frame optical flow map may be reversed by reversing each position in the first interpolation frame optical flow map and the second interpolation frame optical flow map towards an opposite direction, so that the first interpolation frame image and second interpolation frame image are determined according to the reversed first interpolation frame optical flow map and the reversed second interpolation frame optical flow map.

For example, the reversion of the optical flow f_{0->s} of the element moving from the position x₀ corresponding to the moment 0 to the position x₁ corresponding to the moment s may be interpreted as transforming it to an optical flow f_{s->0} of the element moving from the position x₁ corresponding to the moment s to the position x₀ corresponding to the moment 0.

In a possible implementation, reversing the first interpolation frame optical flow map and the second interpolation frame optical flow map to obtain a reversed first interpolation frame optical flow map and a reversed second interpolation frame optical flow map may include:

determining a third interpolation frame image according to the first interpolation frame optical flow map and the t-th frame image, and determining a fourth interpolation frame image according to the second interpolation frame optical flow map and the (t+1)-th frame image;

determining a first neighborhood of any position in the third interpolation frame image, and determining, after reversing in the first interpolation frame optical flow map an optical flow of at least one position in the first neighborhood, a reversed optical flow mean value of at least one position as a reversed optical flow of the position in the third interpolation frame image;

determining a second neighborhood of any position in the fourth interpolation frame image, and determining, after reversing in the second interpolation frame optical flow map an optical flow of at least one position in the second neighborhood, a reversed optical flow mean value of at least one position as a reversed optical flow of the position in the fourth interpolation frame image; and

a reversed optical flow of at least one position in the third interpolation frame image forming the reversed first interpolation frame optical flow map, and a reversed optical flow of at least one position in the fourth interpolation frame image forming the reversed second interpolation frame optical flow map.

For example, firstly the first interpolation frame optical flow map may be projected into the t-th frame image to obtain the third interpolation frame image, wherein the position x₁ in the t-th frame image corresponds to x₁+f_{0->s}(x₁) in the third interpolation frame image, wherein f_{0->s}(x₁) is an optical flow in the first interpolation frame optical flow map which corresponds to the position x₁. Similarly, the second interpolation frame optical flow map may be projected into the (t+1)-th frame image to obtain the fourth interpolation frame image, wherein the position x₂ in the (t+1)-th frame image correspond to x₂+f_{1->s}(x₂) in the fourth interpolation frame image, wherein f_{1->s}(x₂) is an optical flow in the second interpolation frame optical flow map which optical flow to the position x₂.

For the third interpolation frame image, it is possible to determine a first neighborhood of any position in the third interpolation frame image and determine, after reversing the optical flow in the first interpolation frame optical flow map for each position in the first neighborhood, a mean value of the reversed optical flow of each position as the reversed optical flow of the position in the third interpolation frame image.

Illustratively, the following Equation 6 may be used to realize the reversion of the first interpolation frame optical flow map:

$${f}_{s -> 0} ( u ) = \frac{{Σ}_{x + {f}_{0 -> s} ( x ) ∈ N ( u )} ω ( ‖ x + {f}_{0 -> s} ( x ) - u ‖ 2 ) ( - {f}_{0 -> s} ( x ) )}{{Σ}_{x + {f}_{0 -> s} ( x ) ∈ N ( u )} ω ( ‖ x + {f}_{0 -> s} ( x ) - u ‖ 2 )} \qquad ( Equation 6 )$$

wherein, f_{s->0}(u) indicates the optical flow of the position u in the reversed first interpolation frame optical flow map, x indicates the position x located in the first neighborhood after moving f_{0->s}(x), N(u) indicates the first neighborhood, f_{0->s}(x) indicates the optical flow of the position x in the first interpolation frame optical flow map, ω(∥x+f_{0->s}(x)−u∥2) indicates the Gaussian weight of −f_{0->s}(x), wherein

$$ω ( ‖ x + {f}_{0 -> s} ( x ) - u ‖ 2 ) = {e}^{- {‖ x + {f}_{0 -> s} ( x ) - u ‖}^{2 / {σ}^{2}}} .$$

Similarly, the reversion of the second interpolation frame optical flow map may refer to the reversion of the first interpolation frame optical flow map, which will not be detailed herein.

In a possible implementation, determining a first interpolation frame image according to the reversed first interpolation frame optical flow map and the t-th frame image, and determining a second interpolation frame image according to the reversed second interpolation frame optical flow map and the (t+1)-th frame image comprises:

filtering the reversed first interpolation frame optical flow map to obtain a filtered first interpolation frame optical flow map, and filtering the reversed second interpolation frame optical flow map to obtain a filtered second interpolation frame optical flow map; and

determining a first interpolation frame image according to the filtered first interpolation frame optical flow map and the t-th frame image, and determining a second interpolation frame image according to the filtered second interpolation frame optical flow map and the (t+1)-th frame image.

For example, the reversed first interpolation frame optical flow map and the second interpolation frame optical flow map may be sampled, respectively. For example, only one position in the neighborhood is sampled to realize self-adapted filtering of the reversed first interpolation frame optical flow map and the reversed second interpolation frame optical flow map, avoiding the problem of a weighted mean, reducing artifacts in the reversed first interpolation frame optical flow map and the second interpolation frame optical flow map, removing anomalous values, thereby improving the accuracy of the generated interpolation frame image.

In a possible implementation, filtering the reversed first interpolation frame optical flow map to obtain a filtered first interpolation frame optical flow map, and filtering the reversed second interpolation frame optical flow map to obtain a filtered second interpolation frame optical flow map may include:

determining a first sample offset amount and a first residue according to the reversed first interpolation frame optical flow map, and determining a second sample offset amount and a second residue according to the reversed second interpolation frame optical flow map; and

filtering the reversed first interpolation frame optical flow map according to the first sample offset amount and the first residue to obtain a filtered first interpolation frame optical flow map, and filtering the reversed second interpolation frame optical flow map according to the second sample offset amount and the second residue to, obtain a filtered second interpolation frame optical flow map.

For example, the first sample offset amount and the first residue may be determined through the first interpolation frame optical flow map, wherein the first sample offset amount is a mapping of samples of the first interpolation frame optical flow map; and the second sample offset amount and the second residue may be determined through the second interpolation frame optical flow map, wherein the second sample offset amount is a mapping of samples of the second interpolation frame optical flow map.

Illustratively, the filtering of the first interpolation frame optical flow map may be realized based on the following Equation 7:

f′_{s->0}(u)=f₀₋ₛ(u+σ(u))+r(u) (Equation 7)

wherein f′_{s->0}(u) indicates the optical flow of the position u in the filtered first interpolation frame optical flow map, σ(u) indicates the first sample offset amount, r(u) indicates the first residue, f₀₋ₛ(u+σ(u)) indicates the optical flow of the sampled position u in the reversed first interpolation frame optical flow map.

Similarly, the filtering of the second interpolation frame optical flow map may refer to the filtering of the first interpolation frame optical flow map, which is not further detailed herein.

As such, the sampling in the neighborhood is performed depending on the optical flow values about an anomalous value to find a suitable sampling position in the neighborhood, so that the accuracy of the obtained interpolation frame image may be improved by making further reference to the residue.

In a possible implementation, fusing the first interpolation frame image and the second interpolation frame image to obtain an interpolation frame image to be interpolated between the t-th frame image and the (t+1)-th frame image may include:

determining a superimposed weight of at least part of positions in the interpolation frame image according to the first interpolation frame image and the second interpolation frame image; and

obtaining an interpolation frame image to be interpolated between the t-th frame image and the (t+1)-th frame image according to the t-th frame image, the (t+1)-th frame image, and the superimposed weight of the at least part of the positions.

For example, the first interpolation frame image and the second interpolation frame image may be superimposed to obtain the interpolation frame image to be interpolated between the t-th frame image and the (t+1)-th frame image. For example, during the superimposing, element supplementation is performed for positions blocked in the first interpolation frame image based on the second interpolation frame image. As such, an interpolation frame image with high accuracy is obtained.

The superimposed weight of each position in the interpolation frame image may be determined based on the first interpolation frame image and the second interpolation frame image. In a case where the superimposed weight of a position is 0, it is determined that the element in the position is blocked in the first interpolation frame image and is not blocked in the second interpolation frame image, and that there is a need to supplement the element in the position in the first interpolation frame image based on the second interpolation frame image. In a case where the superimposed weight of a position is 1, it is determined that the element in the position is not blocked in the first interpolation frame image, and there is no need to perform the supplementation.

Illustratively, the fusing may be realized according to the following Equation 8:

$${I}_{s} ( u ) = \frac{\begin{matrix}( 1 - s ) m ( u ) {I}_{0} ( u + {f}_{s -> 0 ( u )} ) + \\ s ( 1 - m ( u ) ) {I}_{1} ( u + {f}_{s -> 1 ( u )} )\end{matrix}}{( 1 - s ) m ( u ) + s ( 1 - m ( u ) )} \qquad ( Equation 8 )$$

wherein Iₛ(u) indicates the interpolation frame image, m(u) indicates the superimposed weight of the position u, I₀ indicates the t-th frame image, I₁ indicates the (t+1)-th frame image, f_{s->0}(u) indicates the optical flow of the element from the position u in the interpolation frame image to the t-th frame image, f_{s->1}(u) indicates the optical flow of the element from the position u in the interpolation frame image to the (t+1)-th frame image, I₀(u+f_{s->0(u)}) indicates the first interpolation frame image, and I₁(u+f_{s->1(u)}) indicates the second interpolation frame image.

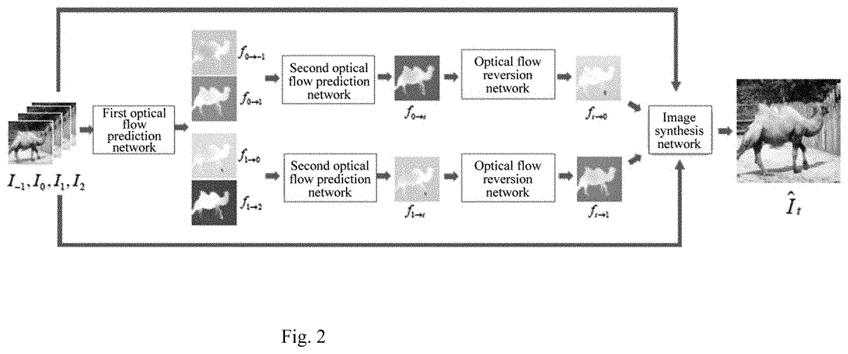

To help a person skilled in the art to better understand the embodiment of the present disclosure, the embodiment of the present disclosure is explained with reference to the specific example shown in FIG. 2.

Referring to FIG. 2, the frame images for interpolation are the image frame I₀ corresponding to the moment 0 and the image frame I₁ corresponding to the moment 1. The image frame I₋₁ and the image frame I₂ are obtained; the image frame I₋₁, the image frame I₀, the image frame I₁, and the image frame I₂ are input into a first optical flow prediction network to perform optical flow prediction, obtaining the first optical flow map of the image frame I₀ to the image frame I₋₁, the second optical flow map of the image frame I₀ to the image frame I₁, the third optical flow map of the image frame I₁ to the image frame I₀, and the fourth optical flow map of the image frame I₁ to the image frame I₂.

The first optical flow map, the second optical flow map, and an interpolation time are input into a second optical flow prediction network to perform optical flow prediction, obtaining the first interpolation frame optical flow map; the third optical flow map, fourth optical flow map, and the interpolation time are input into the second optical flow prediction network to perform optical flow prediction, obtaining the second interpolation frame optical flow map.

After performing, by an optical flow reversing network, optical flow reversion on the first interpolation frame optical flow map, the reversed first interpolation frame optical flow map is obtained; after performing, by the optical flow reversing network, optical flow reversion on the second interpolation frame optical flow map, the reversed second interpolation frame optical flow map is obtained.

At last, the reversed first interpolation frame optical flow map, the second interpolation optical flow map, the image frame I₀, and the image frame I₁ are input into an image synthesis network. Synthesizing the interpolation frame image using the image synthesis network comprises: filtering, by a filter network, the first interpolation frame optical flow map and the second interpolation frame optical flow map, and synthesizing the interpolation frame image according to the filtered first interpolation frame optical flow map and the second interpolation frame optical flow map, and the input images of the image frame I₀ and the image frame I₁.

In a possible implementation, the method may be implemented by a neural network, the method further comprises: training the neural network by a preset training set, the training set including a plurality of sample image groups, each sample image group includes at least an i-th frame sample image and an (i+1)-th frame sample image that are to be interpolated, an (i−1)-th frame sample image, (i+2)-th frame sample image, an interpolation frame sample image interpolated between the i-th frame sample image and the (i+1)-th frame sample image, and an interpolation time of the interpolation frame sample image.

For example, the sample image group may be selected from the video. For example, at least five consecutive images at equal intervals may be acquired from the video as the sample images. Among these images, the first two images and the last two images may be the (i−1)-th frame sample image, the i-th frame sample image, the (i+1)-th frame sample image, the (i+2)-th frame sample image in turn, and the rest image as the interpolation frame sample image interpolated between the i-th frame sample image and the (i+1)-th frame sample image, and time information corresponding to the i-th frame sample image and (i+1)-th frame sample image is the interpolation time.

The neural network may be trained using the above sample image group.

In a possible implementation, the neural network may include: a first optical flow prediction network, a second optical flow prediction network, and an image synthesis network, training the neural network by a preset training set may include:

performing, by the first optical flow prediction network, optical flow prediction on the (i−1)-th frame sample image, the i-th frame sample image, the (i+1)-th frame sample image, and the (i+2)-th frame sample image, respectively, to obtain a first sample optical flow map of the i-th frame sample image to the (i−1)-th frame sample image, a second sample optical flow map of the i-th frame sample image to the (i+1)-th frame sample image, a third sample optical flow map of the (i+1)-th frame sample image to the i-th frame sample image, and a fourth sample optical flow map of the (i+1)-th frame sample image to the (i+2)-th frame sample image, wherein 1<i<I−1, I is a total frame number of images, and i and I are integers;

performing, by the second optical flow prediction network, optical flow prediction according to the first sample optical flow map, the second sample optical flow map, and an interpolation time of the interpolation frame sample image, to obtain a first sample interpolation frame optical flow map;

performing, by the second optical flow prediction network, optical flow prediction according to the third sample optical flow map, the fourth sample optical flow map, and an interpolation time of the interpolation frame sample image, to obtain a second sample interpolation frame optical flow map;

fusing, by the image synthesis network, the i-th frame sample image, the (i+1)-th frame sample image, the first sample interpolation frame optical flow map, and the second sample interpolation frame optical flow map, to obtain an interpolation frame image;

determining an image loss of the neural network through the interpolation frame image and the sample interpolation frame image; and

training the neural network according to the image loss.

For example, the first optical flow prediction network may perform optical flow prediction according to the i-th frame sample image and the (i−1)-th frame sample image, to obtain the first sample optical flow map of the i-th frame sample image to the (i−1)-th frame sample image. The first optical flow prediction network may perform optical flow prediction according to the i-th frame sample image and the (i+1)-th frame sample image, to obtain the second sample optical flow map of the i-th frame sample image to the (i+1)-th frame sample image. The first optical flow prediction network may perform optical flow prediction according to the (i+1)-th frame sample image and the i-th frame sample image, to obtain the third sample optical flow map of the (i+1)-th frame sample image to the i-th frame sample image. The first optical flow prediction network may perform optical flow prediction according to the (i+1)-th frame sample image and the (i+2)-th frame sample image, to obtain the fourth sample optical flow map of the (i+1)-th frame sample image to the (i+2)-th frame sample image.

The first optical flow prediction network may be a pre-trained neural network configured to perform optical flow prediction. The training process may refer to the related art, which is not further detailed herein.

The second optical flow prediction network may perform optical flow prediction according to the first sample optical flow map, the second sample optical flow map, and the interpolation time of the interpolation frame sample image, to obtain a first sample interpolation frame optical flow map. The second optical flow prediction network may perform optical flow prediction according to the third sample optical flow map, the fourth sample optical flow map, and the interpolation time of the interpolation frame sample image, to obtain a second sample interpolation frame optical flow map. The optical flow prediction performed by the second optical flow prediction network may refer to the afore-described embodiment, which is not further detailed herein.

The image synthesis network may fuse, after obtaining the first interpolation frame sample image according to the first interpolation frame optical flow map and the i-th frame sample image and obtaining the second interpolation frame sample image according to the second interpolation frame optical flow map and the (i+1)-th frame sample image, the first interpolation frame sample image and the second interpolation frame sample image. For example, the first interpolation frame sample image and the second interpolation frame sample image are superimposed to obtain the sample image to be interpolated between the i-th frame sample image and the (i+1)-th frame sample image.

According to the interpolation frame sample image and the sample interpolation frame image, the image loss of the neural network may be determined. And then, the network parameters of the neural network may be adjusted according to the image loss, till the image loss of the neural network satisfies a training requirement such as being smaller than a loss threshold value.

In a possible implementation, the neural network further comprises an optical flow reversing network, fusing, by the image synthesis network, the i-th frame sample image, the (i+1)-th frame sample image, the first sample interpolation frame optical flow map, and the second sample interpolation frame optical flow map, to obtain an interpolation frame image may include:

performing, by the optical flow reversing network, optical flow reversion on the first sample interpolation frame optical flow map and the second sample interpolation frame optical flow map, to obtain a reversed first sample interpolation frame optical flow map and a reversed second sample interpolation frame optical flow map; and

fusing, by the image synthesis network, the i-th frame sample image, the (i+1)-th frame sample image, the reversed first sample interpolation frame optical flow map, and the reversed second sample interpolation frame optical flow map, to obtain an interpolation frame image.

For example, the optical flow reversing network may perform optical flow reversion on the first sample interpolation frame optical flow map and the second sample interpolation frame optical flow map. The afore-described embodiment may be referred to for the specific process, which is not further detailed herein. The image synthesis network may, after the optical flow reversion, obtain the first interpolation frame sample image according to the reversed first sample interpolation frame optical flow map and the i-th frame sample image, obtain the second interpolation frame sample image according to the reversed second sample interpolation frame optical flow map and the (i+1)-th frame sample image, and then fuse the first interpolation frame sample image and the second interpolation frame sample image to obtain the sample image to be interpolated between the i-th frame sample image and the (i+1)-th frame sample image.

In a possible implementation, the neural network may further include a filter network, fusing, by the image synthesis network, the i-th frame sample image, the (i+1)-th frame sample image, the reversed first sample interpolation frame optical flow map, and the reversed second sample interpolation frame optical flow map, to obtain an interpolation frame image comprises:

filtering, by the filter network, the first sample interpolation frame optical flow map and the second sample interpolation frame optical flow map to obtain a filtered first sample interpolation frame optical flow map and a filtered second sample interpolation frame optical flow map; and

fusing, by the image synthesis network, the i-th frame sample image, the (i+1)-th frame sample image, the filtered first sample interpolation frame optical flow map, and the filtered second sample interpolation frame optical flow map, to obtain an interpolation frame image.

The filter network may filter the first sample interpolation frame optical flow map and the second sample interpolation frame optical flow map, respectively, to obtain the filtered first sample interpolation frame optical flow map and the filtered second sample interpolation frame optical flow map. The specific process may refer to the afore-described embodiment, which is not further detailed herein.

The image synthesis network may obtain the first interpolation frame sample image according to the filtered first sample interpolation frame optical flow map and the i-th frame sample image, obtain the second interpolation frame sample image according to the filtered second sample interpolation frame optical flow map and the (i+1)-th frame sample image, and then fuse the first interpolation frame sample image and the second interpolation frame sample image to obtain the sample image to be interpolated between the i-th frame sample image and the (i+1)-th frame sample image.

It is appreciated that the afore-described method embodiments by the present disclosure may be combined with one another to form combined embodiments without departing from the principle and the logic, which, due to limited space, will not be further described herein. A person skilled in the art understands that in the afore-described method embodiments, the specific order of execution of the steps should be determined by their function and possible internal logic.

The present disclosure further provides an image processing device, electronic apparatus, a computer readable storage medium, a program, each being capable of realizing any image processing method according to the present disclosure. The corresponding technical solution and the description thereof may refer to the foregoing description of the method and will not be repeated herein.

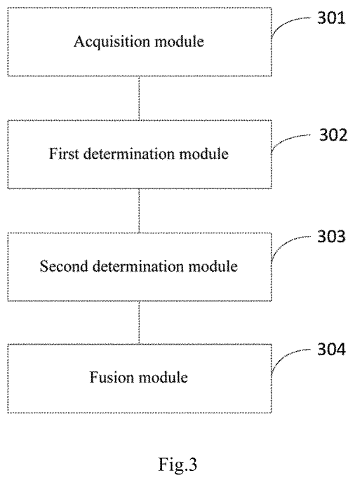

FIG. 3 illustrates a block diagram of the image processing device according to the embodiment of the present disclosure. As shown in FIG. 3, the device comprises:

an acquisition module 301 that may be configured to acquire a first optical flow map of a t-th frame image to a (t−1)-th frame image, a second optical flow map of the t-th frame image to a (t+1)-th frame image, a third optical flow map of the (t+1)-th frame image to the t-th frame image, and a fourth optical flow map of the (t+1)-th frame image to the (t+2)-th frame image, wherein t is an integer;

a first determination module 302 that may be configured to determine a first interpolation frame optical flow map according to the first optical flow map and the second optical flow map, and determine a second interpolation frame optical flow map according to the third optical flow map and the fourth optical flow map;

a second determination module 303 that may be configured to determine a first interpolation frame image according to the first interpolation frame optical flow map and the t-th frame image, and determine a second interpolation frame image according to the second interpolation frame optical flow map image and the (t+1)-th frame image; and

a fusion module 304 that may be configured to fuse the first interpolation frame image and the second interpolation frame image to obtain an interpolation frame image to be interpolated between the t-th frame image and the (t+1)-th frame image.

As such, for the t-th frame image and the (t+1)-th frame image for interpolation, optical flow prediction may be performed on the (t−1)-th frame image, the t-th frame image, the (t+1)-th frame image, and the (t+2)-th frame image, respectively, to obtain the first optical flow map of the t-th frame image to the (t−1)-th frame image, the second optical flow map of the t-th frame image to the (t+1)-th frame image, the third optical flow map of the (t+1)-th frame image to the t-th frame image, and the fourth optical flow map of the (t+1)-th frame image to the (t+2)-th frame image. Further, the first interpolation frame optical flow map is determined according to the first optical flow map, the second optical flow map, and the preset interpolation time; the second interpolation frame optical flow map is determined according to the third optical flow map, the fourth optical flow map, and the interpolation time. The first interpolation frame image is determined according to the first interpolation frame optical flow map and the t-th frame image; and the second interpolation frame image is determined according to the second interpolation frame optical flow map image and the (t+1)-th frame image. The first interpolation frame image and the second interpolation frame image are fused to obtain an interpolation frame image to be interpolated between the t-th frame image and the (t+1)-th frame image. The image processing device provided in the embodiment of the present disclosure is capable of determining the interpolation frame image based on a plurality of frame images and sensing the acceleration of an object motion in the video, thereby improving the accuracy of the obtained interpolation frame image, so that it is possible to make the video with high frame rate obtained by interpolation to be smoother and more natural, and achieve a better visual effect.

In a possible implementation, the first determination module may be configured further to:

determine a first interpolation frame optical flow map according to the first optical flow map, the second optical flow map, and a preset interpolation time, and determine a second interpolation frame optical flow map according to the third optical flow map and the fourth optical flow map, wherein the preset interpolation time is any time in a time interval between a time of acquiring the t-th frame image and a time of acquiring the (t+1)-th frame image.

In a possible implementation, the second determination module may be configured further to:

reverse the first interpolation frame optical flow map and the second interpolation frame optical flow map to obtain a reversed first interpolation frame optical flow map and a reversed second interpolation frame optical flow map; and

determine a first interpolation frame image according to the reversed first interpolation frame optical flow map and the t-th frame image, and determine a second interpolation frame image according to the reversed second interpolation frame optical flow map and the (t+1)-th frame image.

In a possible implementation, the second determination module may be configured further to:

determine a third interpolation frame image according to the first interpolation frame optical flow map and the t-th frame image, and determine a fourth interpolation frame image according to the second interpolation frame optical flow map and the (t+1)-th frame image;

determine a first neighborhood of any position in the third interpolation frame image, and determine, after reversing in the first interpolation frame optical flow map an optical flow of at least one position in the first neighborhood, a reversed optical flow mean value of at least one position as a reversed optical flow of the position in the third interpolation frame image;

determine a second neighborhood of any position in the fourth interpolation frame image, and determine, after reversing in the second interpolation frame optical flow map an optical flow of at least one position in the second neighborhood, a reversed optical flow mean value of at least one position as a reversed optical flow of the position in the fourth interpolation frame image; and

a reversed optical flow of at least one position in the third interpolation frame image forms the reversed first interpolation frame optical flow map, a reversed optical flow of at least one position in the fourth interpolation frame image forms the reversed second interpolation frame optical flow map.

In a possible implementation, the second determination module may be configured further to:

filter the reversed first interpolation frame optical flow map to obtain a filtered first interpolation frame optical flow map, and filter the reversed second interpolation frame optical flow map to obtain a filtered second interpolation frame optical flow map; and

determine a first interpolation frame image according to the filtered first interpolation frame optical flow map and the t-th frame image, and determine a second interpolation frame image according to the filtered second interpolation frame optical flow map and the (t+1)-th frame image.

In a possible implementation, the second determination module may be configured further to:

determine a first sample offset amount and a first residue according to the reversed first interpolation frame optical flow map, and determine a second sample offset amount and a second residue according to the reversed second interpolation frame optical flow map; and

filter the reversed first interpolation frame optical flow map according to the first sample offset amount and the first residue to obtain a filtered first interpolation frame optical flow map, and filter the reversed second interpolation frame optical flow map according to the second sample offset amount and the second residue to obtain a filtered second interpolation frame optical flow map.

In a possible implementation, the fusion module may be configured further to:

determine a superimposed weight of at least part of positions in the interpolation frame image according to the first interpolation frame image and the second interpolation frame image; and

obtain an interpolation frame image to be interpolated between the t-th frame image and the (t+1)-th frame image according to the first interpolation frame image, the second interpolation frame image, and the superimposed weight of at least part of the positions.

In a possible implementation, the acquisition module may be configured further to:

perform optical flow prediction on the t-th frame image and the (t−1)-th frame image, to obtain the first optical flow map of the t-th frame image to the (t−1)-th frame image;

perform optical flow prediction on the t-th frame image and the (t+1)-th frame image, to obtain the second optical flow map of the t-th frame image to the (t+1)-th frame image;

perform optical flow prediction on the (t+1)-th frame image and the t-th frame image, to obtain the third optical flow map of the (t+1)-th frame image to the t-th frame image; and

perform optical flow prediction on the (t+1)-th frame image and the (t+2)-th frame image, to obtain the fourth optical flow map of the (t+1)-th frame image to the (t+2)-th frame image.

In a possible implementation, the device may be implemented by a neural network, the device may further include:

a training module that may be configured to train the neural network by a preset training set, the training set including a plurality of sample image groups, each sample image group includes at least an i-th frame sample image and an (i+1)-th frame sample image that are to be interpolated, an (i−1)-th frame sample image, an (i+2)-th frame image, an interpolation frame sample image interpolated between the i-th frame sample image and the (i+1)-th frame sample image, and an interpolation time of the interpolation frame sample image.

In a possible implementation, the neural network may include: a first optical flow prediction network, a second optical flow prediction network, and an image synthesis network, the training module may be configured further to:

perform, by the first optical flow prediction network, optical flow prediction on the (i−1)-th frame sample image, the i-th frame sample image, the (i+1)-th frame sample image, and the (i+2)-th frame sample image, respectively, to obtain a first sample optical flow map of the i-th frame sample image to the (i−1)-th frame sample image, a second sample optical flow map of the i-th frame sample image to the (i+1)-th frame sample image, a third sample optical flow map of the (i+1)-th frame sample image to the i-th frame sample image, and a fourth sample optical flow map of the (i+1)-th frame sample image to the (i+2)-th frame sample image, wherein 1<i<I−1, I is a total frame number of images, and i and I are integers;

perform, by the second optical flow prediction network, optical flow prediction according to the first sample optical flow map, the second sample optical flow map, and an interpolation time of the interpolation frame sample image, to obtain a first sample interpolation frame optical flow map;

perform, by the second optical flow prediction network, optical flow prediction according to the third sample optical flow map, the fourth sample optical flow map, and an interpolation time of the interpolation frame sample image, to obtain a second sample interpolation frame optical flow map;

fuse, by the image synthesis network, the i-th frame sample image, the (i+1)-th frame sample image, the first sample interpolation frame optical flow map, and the second sample interpolation frame optical flow map, to obtain an interpolation frame image;

determine an image loss of the neural network through the interpolation frame image and the sample interpolation frame image; and

train the neural network according to the image loss.

In a possible implementation, the neural network may further include an optical flow reversing network, the training module may be configured further to:

perform, by the optical flow reversing network, optical flow reversion on the first sample interpolation frame optical flow map and the second sample interpolation frame optical flow map, to obtain a reversed first sample interpolation frame optical flow map and a reversed second sample interpolation frame optical flow map;

fuse, by the image synthesis network, the i-th frame sample image, the (i+1)-th frame sample image, the reversed first sample interpolation frame optical flow map, and the reversed second sample interpolation frame optical flow map, to obtain an interpolation frame image.

In a possible implementation, the neural network may further include a filter network, the training module may be configured further to:

filter, by the filter network, the first sample interpolation frame optical flow map and the second sample interpolation frame optical flow map, to obtain a filtered first sample interpolation frame optical flow map and a filtered second sample interpolation frame optical flow map; and

fuse, by the image synthesis network, the i-th frame sample image, the (i+1)-th frame sample image, the filtered first sample interpolation frame optical flow map, and the filtered second sample interpolation frame optical flow map, to obtain an interpolation frame image.

In some embodiments, functions or modules of the device provided by embodiments of the present disclosure are capable of executing the afore-described method. The specific implementation may be referred to in the description of the method embodiments, which will not be repeated herein to be concise.

The present disclosure further proposes a computer readable storage medium which stores computer program instructions which are executed by a processor to realize the afore-described method.

The computer readable storage medium may be a non-volatile computer readable storage medium.

The present disclosure further proposes an electronic apparatus comprising: a processor; a memory configured to store processor executable instructions; wherein the processor is configured to call instructions stored by the memory to execute the afore-described method.

The present disclosure further provide a computer program product including computer readable codes which, when run on an apparatus, cause a processor of the apparatus to execute instructions for realizing the image searching method provided in any one of the afore-described embodiments.

The present disclosure provides another computer program product configured to store computer readable codes which, when executed, cause the a computer to execute g the image searching method provided in any one of the afore-described embodiments.

The present disclosure further proposes a computer program including computer readable codes which, when run on an electronic apparatus, cause a processor of the electronic apparatus to execute the afore-described method.

The electronic apparatus may be provided as a terminal, a server, or an apparatus in other form.

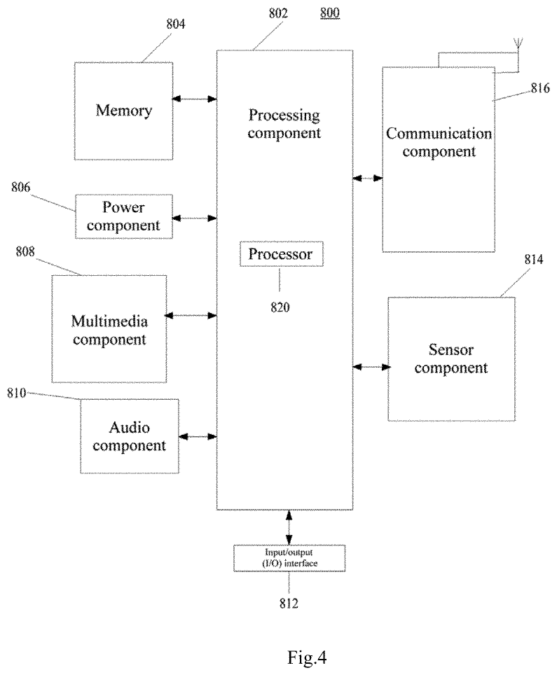

FIG. 4 is a block diagram of an electronic apparatus 800 according to the embodiment of the present disclosure. For example, electronic apparatus 800 may be a mobile phone, a computer, a digital broadcasting terminal, a messaging device, a game console, a tablet device, medical equipment, fitness equipment, a personal digital assistant and the like.

Referring to FIG. 4, electronic apparatus 800 includes one or more of the following components: a processing component 802, a memory 804, a power component 806, a multimedia component 808, an audio component 810, an input/output (I/O) interface 812, a sensor component 814, and a communication component 816.

Processing component 802 is configured to control overall operations of electronic apparatus 800, such as the operations associated with display, telephone calls, data communications, camera operations, and recording operations. Processing component 802 can include one or more processors 820 configured to execute instructions to perform all or part of the steps included in the above-described methods. In addition, processing component 802 may include one or more modules configured to facilitate the interaction between the processing component 802 and other components. For example, processing component 802 may include a multimedia module configured to facilitate the interaction between multimedia component 808 and processing component 802.

Memory 804 is configured to store various types of data to support the operation of electronic apparatus 800. Examples of such data include instructions for any applications or methods operated on or performed by electronic apparatus 800, contact data, phonebook data, messages, pictures, video, etc. Memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power component 806 is configured to provide power to various components of electronic apparatus 800. Power component 806 may include a power management system, one or more power sources, and any other components associated with the generation, management, and distribution of power in electronic apparatus 800.

Multimedia component 808 includes a screen providing an output interface between electronic apparatus 800 and the user. In some embodiments, the screen may include a liquid crystal display (LCD) and a touch panel (TP). If the screen includes the touch panel, the screen may be implemented as a touch screen to receive input signals from the user. The touch panel may include one or more touch sensors configured to sense touches, swipes, and gestures on the touch panel. The touch sensors may sense not only a boundary of a touch or swipe action, but also a period of time and a pressure associated with the touch or swipe action. In some embodiments, multimedia component 808 may include a front camera and/or a rear camera.

The front camera and the rear camera may receive an external multimedia datum while electronic apparatus 800 is in an operation mode, such as a photographing mode or a video mode. Each of the front camera and the rear camera may be a fixed optical lens system or may have focus and/or optical zoom capabilities.

Audio component 810 is configured to output and/or input audio signals. For example, audio component 810 may include a microphone (MIC) configured to receive an external audio signal when electronic apparatus 800 is in an operation mode, such as a call mode, a recording mode, and a voice recognition mode. The received audio signal may be further stored in memory 804 or transmitted via communication component 816. In some embodiments, audio component 810 further includes a speaker configured to output audio signals.

I/O interface 812 is configured to provide an interface between processing component 802 and peripheral interface modules, such as a keyboard, a click wheel, buttons, and the like. The buttons may include, but are not limited to, a home button, a volume button, a starting button, and a locking button.

Sensor component 814 may include one or more sensors configured to provide status assessments of various aspects of electronic apparatus 800. For example, sensor component 814 may detect an open/closed status of electronic apparatus 800, relative positioning of components, e.g., the display and the keypad, of electronic apparatus 800, a change in position of electronic apparatus 800 or a component of electronic apparatus 800, a presence or absence of user contact with electronic apparatus 800, an orientation or an acceleration/deceleration of electronic apparatus 800, and a change in temperature of electronic apparatus 800. Sensor component 814 may include a proximity sensor configured to detect the presence of nearby objects without any physical contact. Sensor component 814 may also include a light sensor, such as a CMOS or CCD image sensor, for use in imaging applications. In some embodiments, sensor component 814 may also include an accelerometer sensor, a gyroscope sensor, a magnetic sensor, a pressure sensor, or a temperature sensor.

Communication component 816 is configured to facilitate wired or wireless communication between electronic apparatus 800 and other devices. Electronic apparatus 800 can access a wireless network based on a communication standard, such as Wi-Fi, 2G, or 3G, or a combination thereof. In some embodiments, communication component 816 receives a broadcast signal or broadcast associated information from an external broadcast management system via a broadcast channel. In an exemplary embodiment, communication component 816 may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In exemplary embodiments, the electronic apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as those included in memory 804, executable by processor 820 of electronic apparatus 800, for performing the above-described methods.

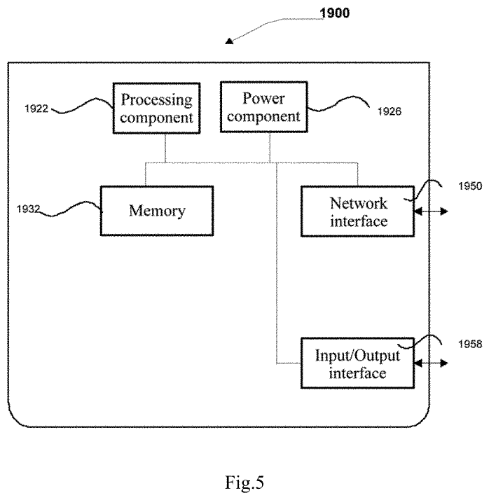

FIG. 5 is a block diagram of an electronic apparatus 1900 according to the embodiment of the present disclosure. For example, the apparatus 1900 may be provided as a server. Referring to FIG. 5, the apparatus 1900 includes a processing component 1922, which further includes one or more processors, and a memory resource represented by a memory 1932 configured to store instructions such as application programs executable for the processing component 1922. The application programs stored in the memory 1932 may include one or more than one module of which each corresponds to a set of instructions. In addition, the processing component 1922 is configured to execute the instructions to execute the abovementioned methods.

The apparatus 1900 may further include a power component 1926 configured to execute power management of the apparatus 1900, a wired or wireless network interface 1950 configured to connect the apparatus 1900 to a network, an Input/Output (I/O) interface 1958. The apparatus 1900 may be operated on the basis of an operating system stored in the memory 1932, such as Window Server™, Mac OS X™, Unix™, Linux™ or Free BSD™.

In an exemplary embodiment, there is also provided a non-transitory computer readable storage medium including instructions, such as those included in memory 1932, executable by processing component 1922 of apparatus 1900, for performing the above-described methods.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or external storage device via network, for example, the Internet, local area network, wide area network and/or wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Each block in the flowchart and/or the block diagrams of the method, device (systems), and computer program product according to the embodiments of the present disclosure, and combinations of blocks in the flowchart and/or block diagram, can be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein comprises a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which comprises one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, can be implemented by dedicated hardware-based systems performing the specified functions or acts, or by combinations of dedicated hardware and computer instructions.

The computer program product may be specifically implemented by hardware, software, or a combination thereof. In an optional embodiment, the computer program product is specifically implemented as a computer storage medium. In another optional embodiment, the computer program product is specifically implemented as a software product, such as a Software Development Kit (SDK), etc.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. An image processing method, comprising:
acquiring a first optical flow map of a t-th frame image to a (t−1)-th frame image, a second optical flow map of the t-th frame image to a (t+1)-th frame image, a third optical flow map of the (t+1)-th frame image to the t-th frame image, and a fourth optical flow map of the (t+1)-th frame image to a (t+2)-th frame image, wherein t is an integer;
determining a first interpolation frame optical flow map according to the first optical flow map and the second optical flow map, and determining a second interpolation frame optical flow map according to the third optical flow map and the fourth optical flow map;
determining a first interpolation frame image according to the first interpolation frame optical flow map and the t-th frame image, and determining a second interpolation frame image according to the second interpolation frame optical flow map and the (t+1)-th frame image; and
fusing the first interpolation frame image and the second interpolation frame image to obtain an interpolation frame image to be interpolated between the t-th frame image and the (t+1)-th frame image.

2. The method according to claim 1, wherein determining the first interpolation frame optical flow map according to the first optical flow map and the second optical flow map, and determining the second interpolation frame optical flow map according to the third optical flow map and the fourth optical flow map comprises:
determining the first interpolation frame optical flow map according to the first optical flow map, the second optical flow map, and a preset interpolation time, and determining the second interpolation frame optical flow map according to the third optical flow map, the fourth optical flow map, and the preset interpolation time, wherein the preset interpolation time is any time in a time interval between a time of acquiring the t-th frame image and a time of acquiring the (t+1)-th frame image.

3. The method according to claim 1, wherein determining the first interpolation frame image according to the first interpolation frame optical flow map and the t-th frame image, and determining the second interpolation frame image according to the second interpolation frame optical flow map and the (t+1)-th frame image comprises:
reversing the first interpolation frame optical flow map and the second interpolation frame optical flow map to obtain a reversed first interpolation frame optical flow map and a reversed second interpolation frame optical flow map; and
determining the first interpolation frame image according to the reversed first interpolation frame optical flow map and the t-th frame image, and determining the second interpolation frame image according to the reversed second interpolation frame optical flow map and the (t+1)-th frame image.

4. The method according to claim 3, wherein reversing the first interpolation frame optical flow map and the second interpolation frame optical flow map to obtain the reversed first interpolation frame optical flow map and the reversed second interpolation frame optical flow map comprises:
determining a third interpolation frame image according to the first interpolation frame optical flow map and the t-th frame image, and determining a fourth interpolation frame image according to the second interpolation frame optical flow map and the (t+1)-th frame image;
determining a first neighborhood of any position in the third interpolation frame image, and determining, after reversing in the first interpolation frame optical flow map an optical flow of at least one position in the first neighborhood, a reversed optical flow mean value of at least one position as a reversed optical flow of the position in the third interpolation frame image;
determining a second neighborhood of any position in the fourth interpolation frame image, and determining, after reversing in the second interpolation frame optical flow map an optical flow of at least one position in the second neighborhood, a reversed optical flow mean value of at least one position as a reversed optical flow of the position in the fourth interpolation frame image; and
the reversed optical flow of at least one position in the third interpolation frame image forming the reversed first interpolation frame optical flow map, and the reversed optical flow of at least one position in the fourth interpolation frame image forming the reversed second interpolation frame optical flow map.

5. The method according to claim 3, wherein determining the first interpolation frame image according to the reversed first interpolation frame optical flow map and the t-th frame image, and determining the second interpolation frame image according to the reversed second interpolation frame optical flow map and the (t+1)-th frame image comprises:
filtering the reversed first interpolation frame optical flow map to obtain a filtered first interpolation frame optical flow map, and filtering the reversed second interpolation frame optical flow map to obtain a filtered second interpolation frame optical flow map; and
determining the first interpolation frame image according to the filtered first interpolation frame optical flow map and the t-th frame image, and determining the second interpolation frame image according to the filtered second interpolation frame optical flow map and the (t+1)-th frame image.

6. The method according to claim 5, wherein filtering the reversed first interpolation frame optical flow map to obtain the filtered first interpolation frame optical flow map, and filtering the reversed second interpolation frame optical flow map to obtain the filtered second interpolation frame optical flow map comprises:
determining a first sample offset amount and a first residue according to the reversed first interpolation frame optical flow map, and determining a second sample offset amount and a second residue according to the reversed second interpolation frame optical flow map; and
filtering the reversed first interpolation frame optical flow map according to the first sample offset amount and the first residue to obtain the filtered first interpolation frame optical flow map, and filtering the reversed second interpolation frame optical flow map according to the second sample offset amount and the second residue to obtain the filtered second interpolation frame optical flow map.

7. The method according to claim 1, wherein fusing the first interpolation frame image and the second interpolation frame image to obtain the interpolation frame image to be interpolated between the t-th frame image and the (t+1)-th frame image comprises:
determining a superimposed weight of at least part of positions in the interpolation frame image according to the first interpolation frame image and the second interpolation frame image; and
obtaining the interpolation frame image to be interpolated between the t-th frame image and the (t+1)-th frame image according to the first interpolation frame image, the second interpolation frame image, and the superimposed weight of the at least part of the positions.

8. The method according to claim 1, wherein acquiring the first optical flow map of the t-th frame image to the (t−1)-th frame image, the second optical flow map of the t-th frame image to the (t+1)-th frame image, the third optical flow map of the (t+1)-th frame image to the t-th frame image, and the fourth optical flow map of the (t+1)-th frame image to the (t+2)-th frame image comprises:
performing optical flow prediction on the t-th frame image and the (t−1)-th frame image to obtain the first optical flow map of the t-th frame image to the (t−1)-th frame image;
performing optical flow prediction on the t-th frame image and the (t+1)-th frame image to obtain the second optical flow map of the t-th frame image to the (t+1)-th frame image;
performing optical flow prediction on the (t+1)-th frame image and the t-th frame image to obtain the third optical flow map of the (t+1)-th frame image to the t-th frame image; and
performing optical flow prediction on the (t+1)-th frame image and the (t+2)-th frame image to obtain the fourth optical flow map of the (t+1)-th frame image to the (t+2)-th frame image.

9. The method according to claim 1, wherein the method is implemented by a neural network, the method further comprises: training the neural network by a preset training set, the training set including a plurality of sample image groups, each sample image group includes at least an i-th frame sample image and an (i+1)-th frame sample image that are to be interpolated, an (i−1)-th frame sample image, an (i+2)-th frame image, an interpolation frame sample image interpolated between the i-th frame sample image and the (i+1)-th frame sample image, and an interpolation time of the interpolation frame sample image.

10. The method according to claim 9, wherein the neural network comprises: a first optical flow prediction network, a second optical flow prediction network, and an image synthesis network, and training the neural network by the preset training set comprises:
performing, by the first optical flow prediction network, optical flow prediction on the (i−1)-th frame sample image, the i-th frame sample image, the (i+1)-th frame sample image, and the (i+2)-th frame sample image, respectively, to obtain a first sample optical flow map of the i-th frame sample image to the (i−1)-th frame sample image, a second sample optical flow map of the i-th frame sample image to the (i+1)-th frame sample image, a third sample optical flow map of the (i+1)-th frame sample image to the i-th frame sample image, and a fourth sample optical flow map of the (i+1)-th frame sample image to the (i+2)-th frame sample image, wherein 1<i<I-1, I is a total frame number of images, and i and I are integers;
performing, by the second optical flow prediction network, optical flow prediction according to the first sample optical flow map, the second sample optical flow map, and the interpolation time of the interpolation frame sample image, to obtain a first sample interpolation frame optical flow map;
performing, by the second optical flow prediction network, optical flow prediction according to the third sample optical flow map, the fourth sample optical flow map, and the interpolation time of the interpolation sample image, to obtain a second sample interpolation frame optical flow map;
fusing, by the image synthesis network, the i-th frame sample image, the (i+1)-th frame sample image, the first sample interpolation frame optical flow map, and the second sample interpolation frame optical flow map, to obtain an interpolation frame image;
determining an image loss of the neural network through the interpolation frame image and the sample interpolation frame image; and
training the neural network according to the image loss.

11. The method of claim 10, wherein the neural network further comprises an optical flow reversing network, and fusing, by the image synthesis network, the i-th frame sample image, the (i+1)-th frame sample image, the first sample interpolation frame optical flow map, and the second sample interpolation frame optical flow map, to obtain the interpolation frame image comprises:
performing, by the optical flow reversing network, optical flow reversion on the first sample interpolation frame optical flow map and the second sample interpolation frame optical flow map, to obtain a reversed first sample interpolation frame optical flow map and a reversed second sample interpolation frame optical flow map; and
fusing, by the image synthesis network, the i-th frame sample image, the (i+1)-th frame sample image, the reversed first sample interpolation frame optical flow map, and the reversed second sample interpolation frame optical flow map, to obtain the interpolation frame image.

12. The method according to claim 11, wherein the neural network further comprises a filter network, and fusing, by the image synthesis network, the i-th frame sample image, the (i+1)-th frame sample image, the reversed first sample interpolation frame optical flow map, and the reversed second sample interpolation frame optical flow map, to obtain the interpolation frame image comprises:
filtering, by the filter network, the reversed first sample interpolation frame optical flow map and the reversed second sample interpolation frame optical flow map, to obtain a filtered first sample interpolation frame optical flow map and a filtered second sample interpolation frame optical flow map; and
fusing, by the image synthesis network, the i-th frame sample image, the (i+1)-th frame sample image, the filtered first sample interpolation frame optical flow map, and the filtered second sample interpolation frame optical flow map, to obtain the interpolation frame image.

13. An image processing device, comprising:
a processor; and
a memory configured to store processor-executable instructions,
wherein the processor is configured to invoke the instructions stored in the memory, so as to:
acquire a first optical flow map of a t-th frame image to a (t−1)-th frame image, a second optical flow map of the t-th frame image to a (t+1)-th frame image, a third optical flow map of the (t+1)-th frame image to the t-th frame image, and a fourth optical flow map of the (t+1)-th frame image to a (t+2)-th frame image, wherein t is an integer;
determine a first interpolation frame optical flow map according to the first optical flow map and the second optical flow map, and determine a second interpolation frame optical flow map according to the third optical flow map and the fourth optical flow map;
determine a first interpolation frame image according to the first interpolation frame optical flow map and the t-th frame image, and determine a second interpolation frame image according to the second interpolation frame optical flow map and the (t+1)-th frame image; and
fuse the first interpolation frame image and the second interpolation frame image to obtain an interpolation frame image to be interpolated between the t-th frame image and the (t+1)-th frame image.

14. The device according to claim 13, wherein determining the first interpolation frame optical flow map according to the first optical flow map and the second optical flow map, and determining the second interpolation frame optical flow map according to the third optical flow map and the fourth optical flow map comprise:
determining the first interpolation frame optical flow map according to the first optical flow map, the second optical flow map, and a preset interpolation time, and determine the second interpolation frame optical flow map according to the third optical flow map, the fourth optical flow map, and the preset interpolation time, wherein the preset interpolation time is any time in a time interval between a time of acquiring the t-th frame image and a time of acquiring the (t+1)-th frame image.

15. The device according to claim 13, wherein determining the first interpolation frame image according to the first interpolation frame optical flow map and the t-th frame image, and determine the second interpolation frame image according to the second interpolation frame optical flow map and the (t+1)-th frame image comprise:
reversing the first interpolation frame optical flow map and the second interpolation frame optical flow map to obtain a reversed first interpolation frame optical flow map and a reversed second interpolation frame optical flow map; and
determining the first interpolation frame image according to the reversed first interpolation frame optical flow map and the t-th frame image, and determining the second interpolation frame image according to the reversed second interpolation frame optical flow map and the (t+1)-th frame image.

16. The device according to claim 15, wherein determining the first interpolation frame image according to the first interpolation frame optical flow map and the t-th frame image, and determine the second interpolation frame image according to the second interpolation frame optical flow map and the (t+1)-th frame image comprise:
determining a third interpolation frame image according to the first interpolation frame optical flow map and the t-th frame image, and determining a fourth interpolation frame image according to the second interpolation frame optical flow map and the (t+1)-th frame image;
determining a first neighborhood of any position in the third interpolation frame image, and determining, after reversing in the first interpolation frame optical flow map an optical flow of at least one position in the first neighborhood, a reversed optical flow mean value of at least one position as a reversed optical flow of the position in the third interpolation frame image;
determining a second neighborhood of any position in the fourth interpolation frame image, and determining, after reversing in the second interpolation frame optical flow map an optical flow of at least one position in the second neighborhood, a reversed optical flow mean value of at least one position as a reversed optical flow of the position in the fourth interpolation frame image; and
the reversed optical flow of at least one position in the third interpolation frame image forming the reversed first interpolation frame optical flow map, and the reversed optical flow of at least one position in the fourth interpolation frame image forming the reversed second interpolation frame optical flow map.

17. The device according to claim 15, wherein determining the first interpolation frame image according to the first interpolation frame optical flow map and the t-th frame image, and determine the second interpolation frame image according to the second interpolation frame optical flow map and the (t+1)-th frame image comprise:
filtering the reversed first interpolation frame optical flow map to obtain a filtered first interpolation frame optical flow map, and filtering the reversed second interpolation frame optical flow map to obtain a filtered second interpolation frame optical flow map; and
determining the first interpolation frame image according to the filtered first interpolation frame optical flow map and the t-th frame image, and determining the second interpolation frame image according to the filtered second interpolation frame optical flow map and the (t+1)-th frame image.

18. The device according to claim 17, wherein determining the first interpolation frame image according to the first interpolation frame optical flow map and the t-th frame image, and determine the second interpolation frame image according to the second interpolation frame optical flow map and the (t+1)-th frame image comprise:
determining a first sample offset amount and a first residue according to the reversed first interpolation frame optical flow map, and determining a second sample offset amount and a second residue according to the reversed second interpolation frame optical flow map; and
filtering the reversed first interpolation frame optical flow map according to the first sample offset amount and the first residue to obtain the filtered first interpolation frame optical flow map, and filtering the reversed second interpolation frame optical flow map according to the second sample offset amount and the second residue to obtain the filtered second interpolation frame optical flow map.

19. The device according to claim 13, wherein fusing the first interpolation frame image and the second interpolation frame image to obtain the interpolation frame image to be interpolated between the t-th frame image and the (t+1)-th frame image comprises:
determining a superimposed weight of at least part of positions in the interpolation frame image according to the first interpolation frame image and the second interpolation frame image; and
obtaining the interpolation frame image to be interpolated between the t-th frame image and the (t+1)-th frame image according to the first interpolation frame image, the second interpolation frame image, and the superimposed weight of the at least part of the positions.

20. A non-transitory computer readable storage medium, having computer program instructions stored thereon, wherein when the computer program instructions are executed by a processor, the processor is caused to perform the operations of:
acquiring a first optical flow map of a t-th frame image to a (t−1)-th frame image, a second optical flow map of the t-th frame image to a (t+1)-th frame image, a third optical flow map of the (t+1)-th frame image to the t-th frame image, and a fourth optical flow map of the (t+1)-th frame image to a (t+2)-th frame image, wherein t is an integer;
determining a first interpolation frame optical flow map according to the first optical flow map and the second optical flow map, and determining a second interpolation frame optical flow map according to the third optical flow map and the fourth optical flow map;
determining a first interpolation frame image according to the first interpolation frame optical flow map and the t-th frame image, and determining a second interpolation frame image according to the second interpolation frame optical flow map and the (t+1)-th frame image; and
fusing the first interpolation frame image and the second interpolation frame image to obtain an interpolation frame image to be interpolated between the t-th frame image and the (t+1)-th frame image.
